(19) United States
(12) Patent Application Publication
(10) Pub. No.: US 2007/0144125 A1
(43) Pub. Date: Jun. 28, 2007

(54) PERIMETER FILTER FRAME HAVING INTERNAL RETAINING FINS

(76) Inventor: Dean R. Duffy, Woodbury, MN (US)

Correspondence Address: 3M INNOVATIVE PROPERTIES COMPANY, PO BOX 33427, ST. PAUL, MN, 55133-3427, US

(21) Appl. No.: 11/275,311

(22) Filed: Dec. 22, 2005

(51) Int. Cl. B01D 46/00

(52) U.S. Cl. 55/495

(57) ABSTRACT

The invention relates to channel frame members having retaining fins projecting from inside walls of the channel frame and framed filters wherein a peripheral edge of a filter medium is inserted into such a channel frame member.

### BACKGROUND

The invention is related to a perimeter filter frame capable of being formed by a continuous extrusion process.

Conventionally, three dimensional filter frames are formed from injection molding or similar type processes. Another approach has been to utilize an aluminum “clinch frame” for framing a high airflow structured filter medium. An aluminum clinch frame is a channel shaped member in which the filter medium is inserted into the channel and then the channel is squeezed to secure the filter medium. Another approach has been to use “fleece frames” for framing a pleated filter structure. A fleece frame is typically a non-woven material that is adhesively bonded to the perimeter of the pleat pack.

### SUMMARY

In one embodiment, the invention is related to a framed filter medium comprising a filter medium having a fluid inlet face and a fluid outlet face with peripheral edges wherein at least one of the peripheral edges is inserted into a channel frame. In one aspect, the channel frame comprises first and second walls having inner and outer surfaces, the walls extending outwardly from a base, each wall having at least one retaining fin projecting from the inner surface of each wall, wherein the retaining fins are capable of gripping the inserted edge of the filter medium.

In another embodiment, the invention is related to a compound channel frame. In one aspect, the compound channel frame comprises two channel frame members attached together with a hinge, each channel frame member comprising first and second walls having inner and outer surfaces, the walls extending outwardly from a base, each wall having at least one retaining fin projecting from the inner surface of each wall. In other aspects, each of the individual channel frame members are attached to one another with a hinge in different orientations and attached to one another by the hinge in the same or different places on each of the channel frame members.

In another embodiment, the invention is related to a filter assembly wherein two or more filter mediums are attached together through the use of two or more compound channel frames. In this embodiment, peripheral edges of the two or more filter mediums are inserted into the channel frame members of at least two compound channel frames.

In another embodiment, the invention is related to a method of making a framed filter media comprising the steps of extruding a continuous channel frame member comprising first and second walls having inner and outer surfaces, the walls extending outwardly from a base, each wall having at least one retaining fin projecting from the inner surface of each wall, cutting or scoring the channel frame member into channel frame lengths and inserting peripheral edges of a filter medium into the channel frame lengths.

In another embodiment, the invention is related to a method of making a compound channel frame member comprising the step of extruding a compound channel frame member through a feedblock and die assembly, wherein the compound channel frame member comprises two channel frame members attached together with a hinge, wherein each channel frame member comprises first and second walls having inner and outer surfaces and the walls extend outwardly from a base, and each wall having at least one retaining fin projecting from the inner surface of each wall.

### BRIEF DESCRIPTION OF THE FIGURES

FIG. 1 is a perspective view of an embodiment of framed filter of the invention.

FIG. 2 is a cross sectional view of an embodiment of a channel frame used in the invention.

FIG. 3 is a cross sectional view of a portion of an embodiment of a framed filter of the invention.

FIG. 4 is a cross sectional view of an embodiment of a channel frame of the invention.

FIG. 5 is a cross sectional view of a filter assembly of the invention.

FIG. 6 is a schematic view of a method of making a channel frame member of the invention.

### DETAILED DESCRIPTION

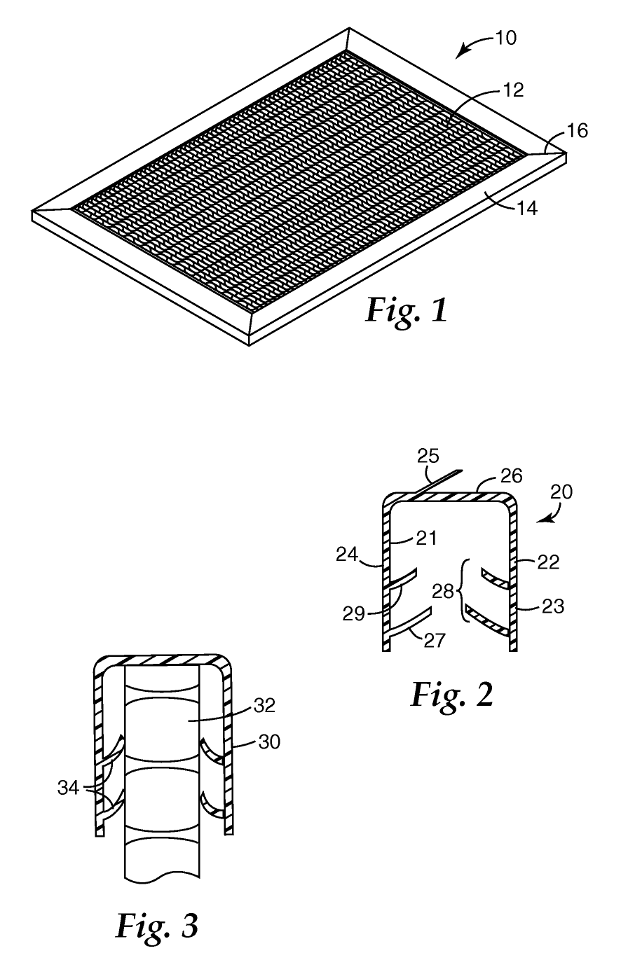

A framed filter medium 10 of the invention is shown in FIG. 1. The framed filter medium comprises a filter medium 12 and a channel frame 14 around the peripheral edges of the filter medium. The channel frame 14 is generally an elongate channel frame member 68 (as shown in FIG. 5), divided into sections by post extrusion cutting, notching and/or scoring. The corner notches 16, desirably 45°, in the first and second walls of the channel frame provide intimate engagement of the respective walls at each corner of the filter.

As shown in more detail in FIG. 2, in this embodiment, a channel frame 20 comprises first 22 and second 24 walls extending outwardly from a base 26. Each wall has an inner surface 21 and an outer surface 23 and retaining fins 28 projecting from the inner surfaces of the first and second walls. In this embodiment, outer retaining fins 27 are longer than inner retaining fins 29. The retaining fins are a generally elastically deformable element where the elasticity is generally provided by the deformation resistance of the material used to form the retaining fins. The retaining fins 28 can be integrally extruded or co-extruded with the walls and base of the channel frame and can be made from the same or different materials. The lengths of the retaining fins as well as the distance between walls and depth of the channel frame member, may be adjusted independently, depending upon, for example, the thickness of the filter medium and the desired amount of retaining force. Specifically, varying the length and shape of the retaining fins influences the roll back resistance of the individual fins.

Further provided in the embodiment shown in FIG. 2 is an optional, integrally extruded or co-extruded sealing lip 25 in the form of a projecting ridge structure on the outside surface of the base which can be formed from the same or different material used in forming the walls 22, 24 and base 26. The sealing lip is also generally elastically deformable and is used to form a seal when engaged with a filter holding frame (not shown). The sealing lips may also be in the form of a profiled structure capable of sealing when compressed, for example having a tubular, circular, or semi-circular structure. Multiple sealing lips may also be formed on the base or walls of the channel frame member, depending upon the application. Useful sealing lips are shown and described in U.S. Pat. No. 6,406,509 B1, incorporated by reference in this application for its description of sealing lips.

The walls and base of the channel frame are generally made from thermoplastic polymers that are relatively rigid, which may also include polymers that provide elastic deformation resistance. Desired levels of frame rigidity may vary depending upon the end use. For example, higher rigidity is desired for some high air velocity applications where the filter media alone cannot withstand deflection forces induced by the airstream. Examples of thermoplastic polymer materials include polyolefins such as: polypropylenes, polyethylenes, ethylene/propylene copolymers, blends, and the like; polyesters; nylons; ABS terpolymers; polyvinylchlorides; and the like. The polymers may also include particulate additives or fillers such as talc, glass fibers, silica, or the like to alter the base polymer properties such as conductivity, fire retardancy, and rigidity.

The retaining fins are generally made from an elastically deformable material, for example, polyolefins such as: polypropylenes, polyethylenes, ethylene/propylene copolymers, ethylenepropylenediene terpolymers, blends thereof, and the like; polyesters; nylons; ABS terpolymers; styrene/diene block copolymers; polyvinylchlorides; and the like. The sealing lip is also generally made from an elastically deformable material, such as those materials listed above and useful for forming retaining fins.

FIG. 3 shows a cross sectional view of a peripheral edge 32 of a filter medium inserted into a channel frame 30 shown in FIG. 2. In this embodiment, the rigidity of the edge of the filter medium is used to deform the retaining fins 34 in a generally inwardly direction to provide frictional force and deformation resistance to removeably retain the filter medium in the frame. The force required to remove the filter medium from the channel frame may be varied by, for example, using a more or less deformable or elastic material to make the retaining fins, or changing the angle of the retaining fins, or both.

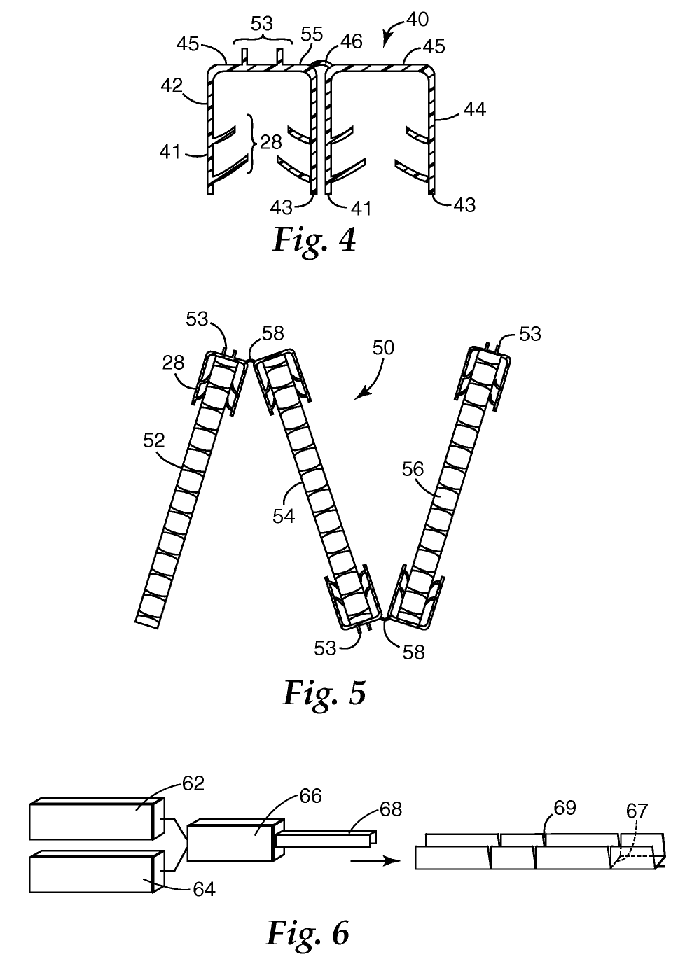

In another embodiment of a channel frame member useful in the present invention and shown in FIG. 4 in cross section, compound channel frame member 40 includes first 42 and second 44 channel frame members operably hinged together at proximate or inside edges by means of a hinge 46 such that the individual channel frame members are in a “parallel” orientation. Each of the hinged channel frame members 42, 44 comprise first and second walls 41, 43 extending outwardly from a base 45 and having retaining fins 28 projecting from the inner surfaces of the first and second walls of each channel frame member. In this embodiment, the living hinge 46 allows a 180° range of motion of one channel frame member relative to the other. The hinge is typically an integral part of the compound or double channel frame member, but may be co-extruded using the same or different materials. In other embodiments, the hinge can be attached in other orientations other than that described above, for example, attached on the outside surface of the base, an outside surface of a wall, in an orientation where one or the channel frame members is in a different orientation that the other, and combinations of such attachment locations such that the attachment location on each of the individual channel frame members is different.

Spacing ribs 53 may be provided on the outside surface 55 of the base of at least one of the channel frame members 42 so that when the framed filters are opened against the spacing ribs, the filter media are held in a predetermined, preferred orientation with respect to each other, for example, horizontally, or any other angle between fully closed and fully opened. Additionally, the spacing ribs may act to maintain proper spacing between the bases of the channel frames and the framed filter. The spacing ribs may also enhance the stiffness of the channel frame member. The spacing ribs 53 may be an integral or co-extruded part of the channel frame and made of the same or different materials than the reset of the channel frame member. The spacing ribs should however be sufficiently rigid to substantially prevent the channel frame members from bending past a substantially horizontal plane.

An alternate embodiment of a framed filter medium 50 of the invention is shown in FIG. 5. In this embodiment, framed filter media 52, 54, 56 are operably hinged together at one edge by means of a hinge 58. The compound channel frame with a hinge 58 allows for two or more or multiple filter media 52, 54, 56 to be joined. For example, the joining of two or more filter media may be used to stiffen the overall framed filter assembly or be used to provide a “folded” or “accordion” filter configuration to improve packaging efficiency for shipment to an end user. This technique may be particularly useful when relatively large sized stiff or rigid filter media is used.

The channel frames of the instant invention can be used to secure various types of filter media. Examples of such filter media include side banded pleated packs, framed pleat packs, and chipboard framed filters. Examples of such filter media are described in U.S. Pat. Nos. 6,521,011; 6,280,824; and 6,589,317 and U.S. Publication No. 2004/0112213 A1, incorporated by reference in this application for the description of filter media.

Polymers useful in forming a structured filter media used in the present invention include, but are not limited to, polyolefins such as polyethylene and polyethylene copolymers, polypropylene and polypropylene copolymers, polyvinylidene diflouride (PVDF), and polytetrafluoroethylene (PTFE). Other polymeric materials include polyesters, polyamides, poly(vinyl chloride), polycarbonates, and polystyrene. Structured film layers can be cast from curable resin materials such as acrylates or epoxies and cured through free radical pathways promoted chemically, by exposure to heat, UV, or electron beam radiation. Preferably, the structured filter media are formed of polymeric material capable of being charged, namely dielectric polymers and blends such as polyolefins or polystyrenes.

Polymeric materials including polymer blends can be modified through melt blending of plasticizing, active, or antimicrobial agents. Surface modification of a filter medium can be accomplished through vapor deposition or covalent grafting of functional moieties using ionizing radiation. Methods and techniques for graft-polymerization of monomers onto polypropylene, for example, by ionizing radiation are disclosed in U.S. Pat. No. 4,950,549 (Rolando et al.) and U.S. Pat. No. 5,078,925 (Rolando et al.). The polymers may also contain additives that impart various properties into the polymeric structured layer.

A method of making a channel frame member is shown in FIG. 6. Two extruders 62, 64 containing the same or different polymer materials are used to feed molten polymer into a feedblock and die assembly 66. The feedblock and die assembly are adapted to be capable of providing an extruded member 68 having a profile similar to that shown in FIG. 2 or FIG. 4. Generally, the walls and base of the channel frame member are made from the same polymeric material. The retaining fins and sealing lip can each be formed from a different polymeric material, or from the same polymeric material than the walls and base of the channel frame member depending upon the particular application. After the channel frame members are formed, they may be cut to length and/or scored 67 and/or notched 69 for the particular application. Scoring and notching would allow the channel frame member to be oriented along the formed living hinge and placed along the perimeter of a filter medium, without cutting the extruded member into individual pieces. Alternatively, if a compound channel frame member described above is formed, the channel frame member may be cut along the formed hinge to provide separate channel frame members. The filter medium is then simply inserted into the channel to form a framed filter or filter assembly.

### EXAMPLE

Two extruders were connected to a feed block and co-extrusion die assembly capable of producing a continuous channel frame member, including retaining fins and a living hinge, and having a profile similar to that illustrated in FIG. 4. The sidewalls and base portions of the channel frame member were about 0.75 to about 1.00 mm thick, the channel was about 8.9 mm wide and about 10 mm deep, the retaining fins were about 1.3 mm and 2.2 mm long (inside and outside, respectively), and the living hinge was about 2 mm long and had a thickness of about 0.4 mm. The sidewalls and base portions of the channel frame member were formed from a talc filled polypropylene resin (20% by weight talc) available from A. Schulman Inc., Akron, Ohio, under the trade designation “POLYFORT” which was delivered to the feedblock/die assembly as a molten stream at a temperature of about 205° C. from the first extruder. The retaining fins and living hinge portions of the channel frame member were formed from a thermoplastic elastomer resin, available from Advanced Elastomer Systems, L.P., Akron, Ohio, under the trade designation “SANTOPRENE” which was delivered to the feedblock/die assembly as a molten stream at a temperature of about 205° C. from the second extruder.

What is claimed is:

1. A framed filter medium comprising a filter medium having a fluid inlet face and a fluid outlet face with peripheral edges with at least one edge of the filter media inserted into a channel frame comprising first and second walls having inner and outer surfaces, the walls extending outwardly from a base, each wall having at least one retaining fin projecting from the inner surface of each wall, the retaining fins gripping the inserted edge of the filter medium.

2. The framed filter medium of claim 1 further comprising at least one sealing lip.

3. The framed filter medium of claim 2 wherein the at least one sealing lip is attached to an outside surface of the base.

4. The framed filter of claim 3 wherein the at least one sealing lip is a thin projecting ridge structure.

5. The framed filter of claim 3 wherein the at least one sealing lip is a profiled structure capable sealing when compressed.

6. The framed filter medium of claim 1 further comprising at least two sealing lips.

7. The framed filter medium of claim 1 wherein each wall has at least two retaining fins projecting from the inner surfaces of the wall.

8. The framed filter medium of claim 7 wherein each retaining fin of the at least two retaining fins projecting from each wall has different lengths.

9. The framed filter medium of claim 7 wherein each wall has outer retaining fins and inner retaining fins projecting from the inner surfaces of the walls.

10. The framed filter medium of claim 9 wherein outer retaining fins have a different length than the inner retaining fins.

11. The framed filter medium of claim 1 wherein the filter medium comprises a cellular structured filtration media, side banded pleated packs, framed pleat packs, or chipboard framed filters.

12. The framed filter medium of claim 1 wherein the retaining fins are formed of a thermoplastic elastomer.

13. The framed filter medium of claim 2 wherein the sealing lip is formed from a thermoplastic elastomer.

14. The framed filter medium of claim 1 wherein the channel frame is attached as a single, continuous member around the filter medium.

15. The framed filter medium of claim 1 wherein the channel frame is in two or more pieces around the filter medium.

16. A compound channel frame comprising:
two channel frame members attached together with a hinge, each channel frame member comprising first and second walls having inner and outer surfaces, the walls extending outwardly from a base, each wall having at least one retaining fin projecting from the inner surface of each wall.

17. The compound channel frame of claim 16 wherein the hinge is attached to an edge of each channel frame member.

18. The compound channel frame of claim 16 wherein the two channel frame members have different orientations.

19. The compound channel frame of claim 16 further comprising at least one sealing lip.

20. The compound channel frame of claim 16 further comprising spacing ribs on at least one of the channel frames.

21. The compound channel frame of claim 16 wherein each wall of each channel frame has at least two retaining fins projecting from the inner surfaces of the wall.

22. The compound channel frame of claim 16 wherein the hinge is formed from a thermoplastic elastomer.

23. A framed filter assembly comprising:
at least two filter mediums having a fluid inlet face and a fluid outlet face with peripheral edges with at least one edge of the filter media inserted into channel frame members of at least two compound channel frames, wherein each of the compound channel frames comprises two channel frame members attached together with a hinge, each channel frame member comprising first and second walls having inner and outer surfaces, the walls extending outwardly from a base, each wall having at least one retaining fin projecting from the inner surface of each wall.

24. A method of making a framed filter media comprising the steps of:
extruding a continuous channel frame member comprising first and second walls having inner and outer surfaces, the walls extending outwardly from a base, each wall having at least one retaining fin projecting from the inner surface of each wall;
cutting the channel frame member into channel frame lengths; and
inserting peripheral edges of a filter medium into the channel frame lengths.

25. The method of claim 24 further including extruding at least one sealing lip on an outside surface of the base.

26. The method of claim 24 further including the step of notching ends of channel frame lengths to form corner notches.

27. The method of claim 24 wherein each wall has at least two retaining fins projecting from the inner surface of each wall.

28. A method of making a compound channel frame member comprising the step of:
extruding a compound channel frame member through a feedblock and die assembly, wherein the compound channel frame member comprises two channel frame members attached together with a hinge, wherein each channel frame member comprises first and second walls having inner and outer surfaces and the walls extend outwardly from a base, and each wall having at least one retaining fin projecting from the inner surface of each wall.

29. The method of claim 28 wherein the at least one retaining fin on each surface is coextruded.

30. The method of claim 28 wherein the living hinge is coextruded.

31. The method of claim 28 wherein the living hinge is attached to an edge of each channel frame member.

32. The method of claim 28 wherein the retaining fins and the living hinge are extruded integrally with the walls and base.
